(19) United States
(12) Patent Application Publication
(10) Pub. No.: US 2023/0224964 A1
(43) Pub. Date: Jul. 13, 2023

(54) TECHNIQUES FOR SCHEDULING CROSS-COMPONENT CARRIERS IN UNLICENSED BANDS

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Hao XU, Beijing (CN); Rajat PRAKASH, San Diego, CA (US)

(21) Appl. No.: 17/997,794

(22) PCT Filed: Jul. 8, 2020
(86) PCT No.: PCT/CN2020/100768

§ 371 Date: Nov. 2, 2022

(51) Int. Cl. H04W 74/08; H04L 27/00; H04L 5/00

(52) U.S. Cl. CPC H04W 74/0816; H04L 27/0006; H04L 5/0094; H04L 5/001

(57) ABSTRACT

Various aspects of the present disclosure generally relate to wireless communication. In some aspects, a user equipment may receive, from a base station, a broadcast message that indicates a plurality of occasions for a control resource set, wherein the plurality of occasions are associated with a plurality of component carriers that are associated with an unlicensed band; and monitor at least one of the plurality of occasions for the control resource set. In some aspects, a user equipment may receive, from a base station, a control message that indicates a plurality of occasions for at least one control resource set, wherein the plurality of occasions are associated with a plurality of component carriers that are associated with an unlicensed band; and monitor at least one of the plurality of occasions for the at least one control resource set. Numerous other aspects are provided.

### FIELD OF THE DISCLOSURE

Aspects of the present disclosure generally relate to wireless communication and to techniques and apparatuses for scheduling cross-component carriers in unlicensed bands.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment includes: receiving, from a base station, a broadcast message that indicates a plurality of occasions for a control resource set, wherein the plurality of occasions are associated with a plurality of component carriers, and wherein the plurality of component carriers are associated with an unlicensed band; and monitoring, based at least in part on the broadcast message, at least one occasion of the plurality of occasions for the control resource set.

In some aspects, the method further includes receiving, based at least in part on the monitoring, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the UE receives the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the UE receives the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a method of wireless communication performed by a base station includes: transmitting, to a user equipment (UE), a broadcast message that indicates a plurality of occasions for a control resource set, wherein the plurality of occasions are associated with a plurality of component carriers, and wherein the plurality of component carriers are associated with an unlicensed band; and transmitting, to the UE and based at least in part on the transmission of the broadcast message, the control resource set in at least one occasion of the plurality of occasions.

In some aspects, the method further includes transmitting, to the UE and based at least in part on the transmission of the control resource set, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the base station transmits the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the base station transmits the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a method of wireless communication performed by a UE includes: receiving, from a base station, a control message that indicates a plurality of occasions for at least one control resource set, wherein the plurality of occasions are associated with a plurality of component carriers, and wherein the plurality of component carriers are associated with an unlicensed band; and monitoring, based at least in part on the control message, at least one occasion of the plurality of occasions for the at least one control resource set.

In some aspects, the method further includes receiving, based at least in part on the monitoring, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the method further includes decoding scheduling information, received from the base station, based at least in part on the repetition pattern.

In some aspects, the control message further indicates, for each occasion of the plurality of occasions, an offset based at least in part on a beginning of a search space within the occasion.

In some aspects, a method of wireless communication performed by a base station includes: transmitting, to a UE, a control message that indicates a plurality of occasions for at least one control resource set, wherein the plurality of occasions are associated with a plurality of component carriers, and wherein the plurality of component carriers are associated with an unlicensed band; and transmitting, to the UE and based at least in part on the transmission of the control message, the at least one control resource set in at least one occasion of the plurality of occasions.

In some aspects, the method further includes transmitting, to the UE and based at least in part on the transmission of the at least one control resource set, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the method further includes transmitting scheduling information, to the UE, wherein the scheduling information is repeated based at least in part on the repetition pattern.

In some aspects, the control message further indicates, for each occasion of the plurality of occasions, an offset based at least in part on a beginning of a search space within the occasion.

In some aspects, a UE for wireless communication includes: a memory; and one or more processors coupled to the memory, the memory and the one or more processors configured to: receive, from a base station, a broadcast message that indicates a plurality of occasions for a control resource set, wherein the plurality of occasions are associated with a plurality of component carriers, and wherein the plurality of component carriers are associated with an unlicensed band; and monitor, based at least in part on the broadcast message, at least one occasion of the plurality of occasions for the control resource set.

In some aspects, the one or more processors are further configured to receive, based at least in part on the monitoring, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the UE receives the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the UE receives the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a base station for wireless communication includes: a memory; and one or more processors coupled to the memory, the memory and the one or more processors configured to: transmit, to a UE, a broadcast message that indicates a plurality of occasions for a control resource set, wherein the plurality of occasions are associated with a plurality of component carriers, and wherein the plurality of component carriers are associated with an unlicensed band; and transmit, to the UE and based at least in part on the transmission of the broadcast message, the control resource set in at least one occasion of the plurality of occasions.

In some aspects, the one or more processors are further configured to transmit, to the UE and based at least in part on the transmission of the control resource set, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the base station transmits the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the base station transmits the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a UE for wireless communication includes: a memory; and one or more processors coupled to the memory, the memory and the one or more processors configured to: receive, from a base station, a control message that indicates a plurality of occasions for at least one control resource set, wherein the plurality of occasions are associated with a plurality of component carriers, and wherein the plurality of component carriers are associated with an unlicensed band; and monitor, based at least in part on the control message, at least one occasion of the plurality of occasions for the at least one control resource set.

In some aspects, the one or more processors are further configured to receive, based at least in part on the monitoring, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the one or more processors are further configured to decode scheduling information, received from the base station, based at least in part on the repetition pattern.

In some aspects, the control message further indicates, for each occasion of the plurality of occasions, an offset based at least in part on a beginning of a search space within the occasion.

In some aspects, a base station for wireless communication includes: a memory; and one or more processors coupled to the memory, the memory and the one or more processors configured to: transmit, to a UE, a control message that indicates a plurality of occasions for at least one control resource set, wherein the plurality of occasions are associated with a plurality of component carriers, and wherein the plurality of component carriers are associated with an unlicensed band; and transmit, to the UE and based at least in part on the transmission of the control message, the at least one control resource set in at least one occasion of the plurality of occasions.

In some aspects, the one or more processors are further configured to transmit, to the UE and based at least in part on the transmission of the at least one control resource set, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the one or more processors are further configured to transmit scheduling information, to the UE, wherein the scheduling information is repeated based at least in part on the repetition pattern.

In some aspects, the control message further indicates, for each occasion of the plurality of occasions, an offset based at least in part on a beginning of a search space within the occasion.

In some aspects, a non-transitory computer-readable medium storing a set of instructions for wireless communication includes: one or more instructions that, when executed by one or more processors of a UE, cause the UE to: receive, from a base station, a broadcast message that indicates a plurality of occasions for a control resource set, wherein the plurality of occasions are associated with a plurality of component carriers, and wherein the plurality of component carriers are associated with an unlicensed band; and monitor, based at least in part on the broadcast message, at least one occasion of the plurality of occasions for the control resource set.

In some aspects, the one or more instructions further cause the UE to receive, based at least in part on the monitoring, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the UE receives the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the UE receives the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a non-transitory computer-readable medium storing a set of instructions for wireless communication includes: one or more instructions that, when executed by one or more processors of a base station, cause the base station to: transmit, to a UE, a broadcast message that indicates a plurality of occasions for a control resource set, wherein the plurality of occasions are associated with a plurality of component carriers, and wherein the plurality of component carriers are associated with an unlicensed band; and transmit, to the UE and based at least in part on the transmission of the broadcast message, the control resource set in at least one occasion of the plurality of occasions.

In some aspects, the one or more instructions further cause the base station to transmit, to the UE and based at least in part on the transmission of the control resource set, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the base station transmits the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the base station transmits the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, a non-transitory computer-readable medium storing a set of instructions for wireless communication includes: one or more instructions that, when executed by one or more processors of a UE, cause the UE to: receive, from a base station, a control message that indicates a plurality of occasions for at least one control resource set, wherein the plurality of occasions are associated with a plurality of component carriers, and wherein the plurality of component carriers are associated with an unlicensed band; and monitor, based at least in part on the control message, at least one occasion of the plurality of occasions for the at least one control resource set.

In some aspects, the one or more instructions further cause the UE to receive, based at least in part on the monitoring, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the one or more instructions further cause the UE to decode scheduling information, received from the base station, based at least in part on the repetition pattern.

In some aspects, the control message further indicates, for each occasion of the plurality of occasions, an offset based at least in part on a beginning of a search space within the occasion.

In some aspects, a non-transitory computer-readable medium storing a set of instructions for wireless communication includes: one or more instructions that, when executed by one or more processors of a base station, cause the base station to: transmit, to a UE, a control message that indicates a plurality of occasions for at least one control resource set, wherein the plurality of occasions are associated with a plurality of component carriers, and wherein the plurality of component carriers are associated with an unlicensed band; and transmit, to the UE and based at least in part on the transmission of the control message, the at least one control resource set in at least one occasion of the plurality of occasions.

In some aspects, the one or more instructions further cause the base station to transmit, to the UE and based at least in part on the transmission of the at least one control resource set, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the one or more instructions further cause the base station to transmit scheduling information, to the UE, wherein the scheduling information is repeated based at least in part on the repetition pattern.

In some aspects, the control message further indicates, for each occasion of the plurality of occasions, an offset based at least in part on a beginning of a search space within the occasion.

In some aspects, an apparatus for wireless communication includes: means for receiving, from a base station, a broadcast message that indicates a plurality of occasions for a control resource set, wherein the plurality of occasions are associated with a plurality of component carriers, and wherein the plurality of component carriers are associated with an unlicensed band; and means for monitoring, based at least in part on the broadcast message, at least one occasion of the plurality of occasions for the control resource set.

In some aspects, the apparatus further includes means for receiving, based at least in part on the monitoring, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the UE receives the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the UE receives the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, an apparatus for wireless communication includes: means for transmitting, to a UE, a broadcast message that indicates a plurality of occasions for a control resource set, wherein the plurality of occasions are associated with a plurality of component carriers, and wherein the plurality of component carriers are associated with an unlicensed band; and means for transmitting, to the UE and based at least in part on the transmission of the broadcast message, the control resource set in at least one occasion of the plurality of occasions.

In some aspects, the apparatus further includes means for transmitting, to the UE and based at least in part on the transmission of the control resource set, another broadcast message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the base station transmits the control resource set in a bandwidth that is larger than 80 MHz.

In some aspects, the plurality of occasions are contiguous along the unlicensed band.

In some aspects, the plurality of occasions are separated along the unlicensed band, and the broadcast message further indicates one or more gaps separating the plurality of occasions along the unlicensed band.

In some aspects, the control resource set is repeated across the plurality of occasions, and the base station transmits the control resource set across the plurality of occasions.

In some aspects, the broadcast message further indicates a number of symbols in the control resource set, and the number of symbols is no more than two.

In some aspects, the broadcast message further indicates an offset based at least in part on which occasion of the plurality of occasions includes a synchronization signal.

In some aspects, an apparatus for wireless communication includes: means for receiving, from a base station, a control message that indicates a plurality of occasions for at least one control resource set, wherein the plurality of occasions are associated with a plurality of component carriers, and wherein the plurality of component carriers are associated with an unlicensed band; and means for monitoring, based at least in part on the control message, at least one occasion of the plurality of occasions for the at least one control resource set.

In some aspects, the apparatus further includes means for receiving, based at least in part on the monitoring, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the apparatus further includes means for decoding scheduling information, received from the base station, based at least in part on the repetition pattern.

In some aspects, the control message further indicates, for each occasion of the plurality of occasions, an offset based at least in part on a beginning of a search space within the occasion.

In some aspects, an apparatus for wireless communication includes: means for transmitting, to a UE, a control message that indicates a plurality of occasions for at least one control resource set, wherein the plurality of occasions are associated with a plurality of component carriers, and wherein the plurality of component carriers are associated with an unlicensed band; and means for transmitting, to the UE and based at least in part on the transmission of the control message, the at least one control resource set in at least one occasion of the plurality of occasions.

In some aspects, the apparatus further includes means for transmitting, to the UE and based at least in part on the transmission of the at least one control resource set, another control message that schedules further transmissions from the base station.

In some aspects, the unlicensed band includes at least one of a 5 GHz band, a 6 GHz band, or a combination thereof.

In some aspects, each occasion of the plurality of occasions has a width of no more than 80 MHz.

In some aspects, the at least one control resource set includes a plurality of control resource sets, and each control resource set of the plurality of control resource sets corresponds to a respective occasion of the plurality of occasions.

In some aspects, the control message further indicates a repetition pattern, within the plurality of occasions, for the at least one control resource set.

In some aspects, the control message includes a bitmap that indicates the repetition pattern.

In some aspects, the apparatus further includes means for transmitting scheduling information, to the UE, wherein the scheduling information is repeated based at least in part on the repetition pattern.

In some aspects, the control message further indicates, for each occasion of the plurality of occasions, an offset based at least in part on a beginning of a search space within the occasion.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example resource structure for wireless communication, in accordance with various aspects of the present disclosure.

FIG. 4 is a diagram illustrating examples of carrier aggregation, in accordance with various aspects of the present disclosure.

FIG. 5 is a diagram illustrating an example of transmitting a control resource set in a wide bandwidth, in accordance with various aspects of the present disclosure.

FIG. 6 is a diagram illustrating an example of repeating a control resource set in a wide bandwidth, in accordance with various aspects of the present disclosure.

FIG. 7 is a diagram illustrating an example of monitoring a wide bandwidth for a repeated control resource set, in accordance with various aspects of the present disclosure.

FIG. 8 is a diagram illustrating an example process performed by a UE, in accordance with various aspects of the present disclosure.

FIG. 9 is a diagram illustrating an example process performed by a base station, in accordance with various aspects of the present disclosure.

FIG. 10 is a diagram illustrating another example process performed by a UE, in accordance with various aspects of the present disclosure.

FIG. 11 is a diagram illustrating another example process performed by a base station, in accordance with various aspects of the present disclosure.

FIGS. 12-13 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

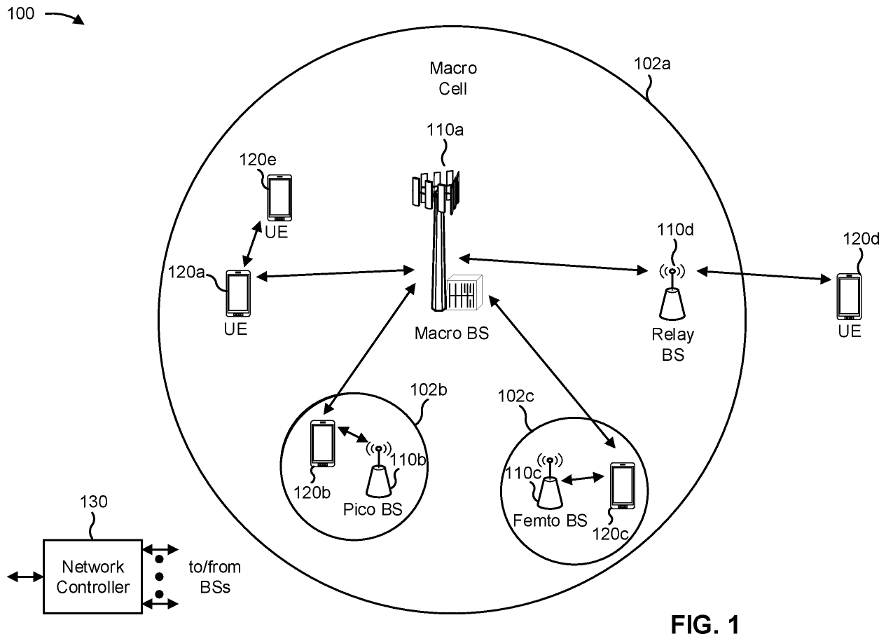

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types (e.g., macro BSs, pico BSs, femto BSs, relay BSs, and/or the like). These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another (e.g., directly or indirectly via a wireless or wireline backhaul).

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

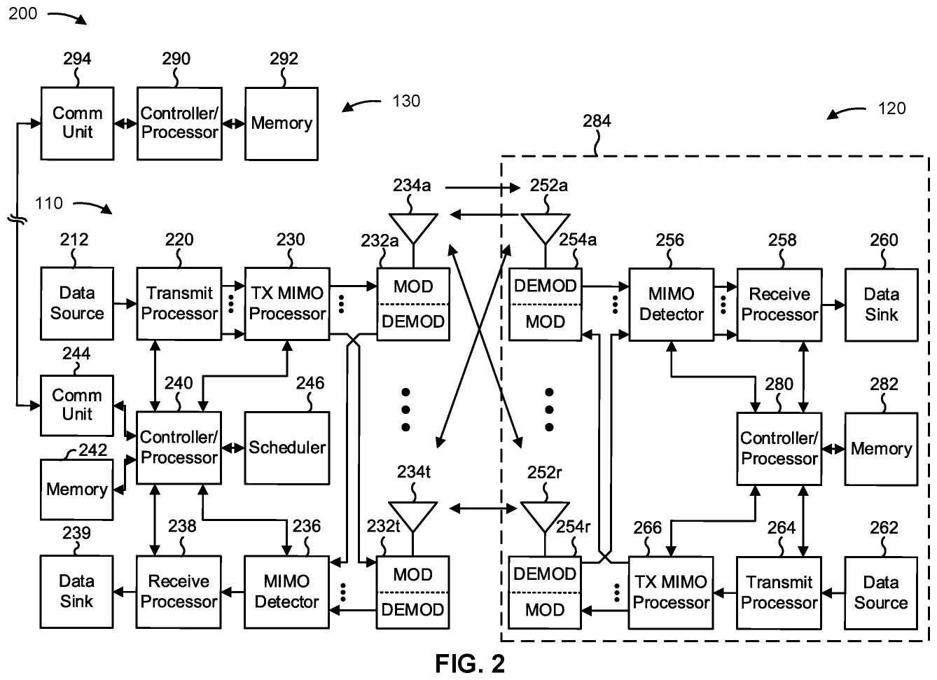

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

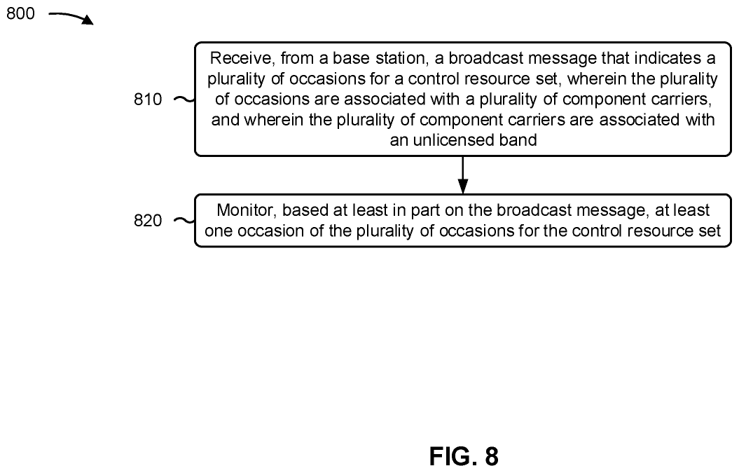

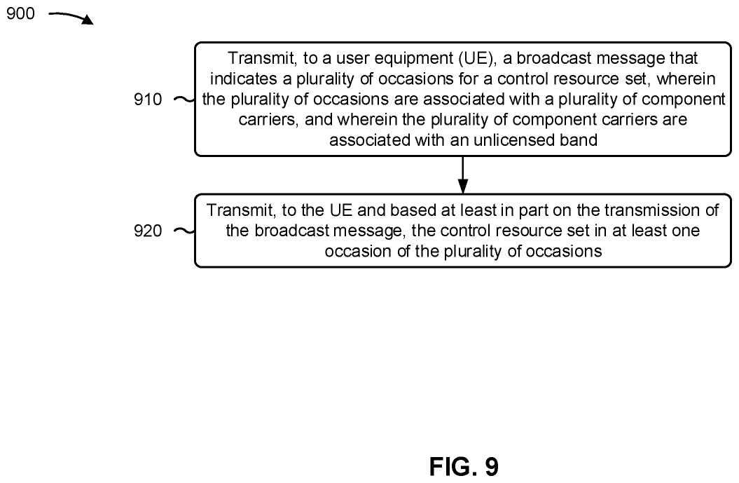

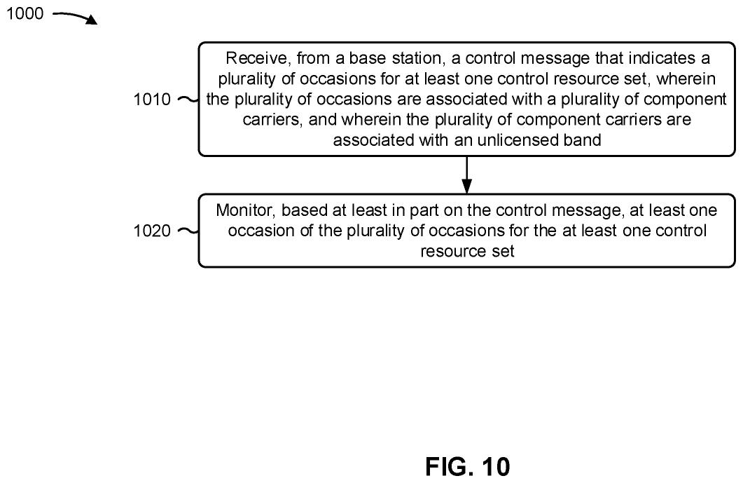

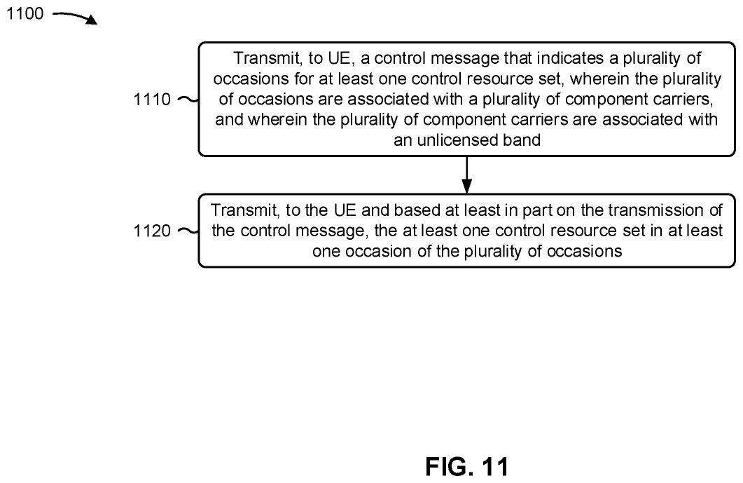

Controller/processor 240 of base station 110, controller/processor 280 of UE 120, and/or any other component(s) of FIG. 2 may perform one or more techniques associated with scheduling cross-component carriers in unlicensed bands, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some aspects, executing instructions may include running the instructions, converting the instructions, compiling the instructions, interpreting the instructions, and/or the like.

In some aspects, a UE (e.g., UE 120) may include means for receiving, from a base station, a broadcast message that indicates a plurality of occasions for a control resource set, wherein the plurality of occasions are associated with a plurality of component carriers, and wherein the plurality of component carriers are associated with an unlicensed band; means for monitoring, based at least in part on the broadcast message, at least one occasion of the plurality of occasions for the control resource set; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a UE (e.g., UE 120) may include means for receiving, from a base station, a control message that indicates a plurality of occasions for at least one control resource set, wherein the plurality of occasions are associated with a plurality of component carriers, and wherein the plurality of component carriers are associated with an unlicensed band; means for monitoring, based at least in part on the reception of the control message, at least one occasion of the plurality of occasions for the at least one control resource set; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a base station (e.g., base station 110) may include means for transmitting, to a UE, a broadcast message that indicates a plurality of occasions for a control resource set, wherein the plurality of occasions are associated with a plurality of component carriers, and wherein the plurality of component carriers are associated with an unlicensed band; means for transmitting, to the UE and based at least in part on the transmission of the broadcast message, the control resource set in at least one occasion of the plurality of occasions; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

In some aspects, a base station (e.g., base station 110) may include means for transmitting, to a UE, a control message that indicates a plurality of occasions for at least one control resource set, wherein the plurality of occasions are associated with a plurality of component carriers, and wherein the plurality of component carriers are associated with an unlicensed band; means for transmitting, to the UE and based at least in part on the transmission of the control message, the at least one control resource set in at least one occasion of the plurality of occasions; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

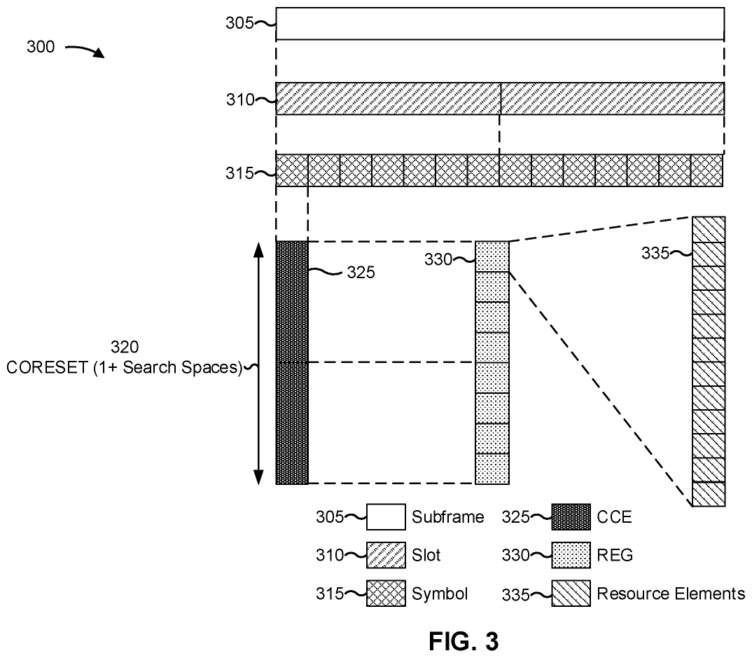

FIG. 3 is a diagram illustrating an example resource structure 300 for wireless communication, in accordance with various aspects of the present disclosure. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, and/or the like). In some aspects, different types of transmission time intervals (TTIs) may be used, other than subframes and/or slots. A slot 310 may include multiple symbols 315, such as 7 symbols or 14 symbols per slot.

The potential control region of a slot 310 may be referred to as a control resource set (CORESET) 320 and may be structured to support an efficient use of resources, such as by flexible configuration or reconfiguration of resources of the CORESET 320 for one or more physical downlink control channels (PDCCHs), one or more physical downlink shared channels (PDSCHs), and/or the like. In some aspects, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain. In 5G, a quantity of resources included in the CORESET 320 may be flexibly configured, such as by using radio resource control (RRC) signaling to indicate a frequency domain region (e.g., a quantity of resource blocks) and/or a time domain region (e.g., a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include downlink control information (DCI) that is used to provide control information for wireless communication. A base station may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some aspects, different aggregation levels may be used, such as 1, 4, 8, 16, and/or the like.

Each CCE 325 may include a fixed quantity of resource element groups (REGs) 330, shown as 4 REGs 330, or may include a variable quantity of REGs 330. In some aspects, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain.

A search space may include all possible locations (e.g., in time and/or frequency) where a PDCCH may be located. A CORESET 320 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs), an aggregation level being used, and/or the like. A possible location (e.g., in time and/or frequency) for a PDCCH may be referred to as a PDCCH candidate, and the set of all possible PDCCH locations may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space.

A CORESET 320 may be interleaved or non-interleaved. An interleaved CORESET 320 may have CCE-to-REG mapping such that adjacent CCEs are mapped to scattered REG bundles in the frequency domain (e.g., adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

As indicated above, FIG. 3 is provided as an example. Other examples may differ from what is described with respect to FIG. 3.

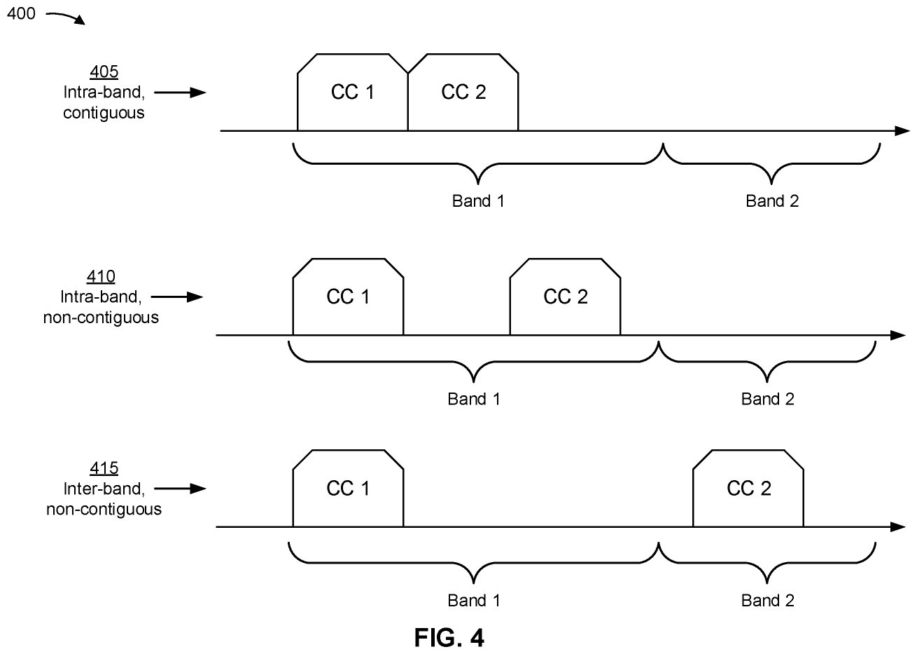

FIG. 4 is a diagram illustrating examples 400 of carrier aggregation, in accordance with various aspects of the present disclosure. Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in a radio resource control (RRC) message, downlink control information (DCI), and/or the like.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

As indicated above, FIG. 4 is provided as an example. Other examples may differ from what is described with regard to FIG. 4.

In unlicensed bands, such as 5 GHz, 6 GHz, and/or the like, effective isotropic radiated power (EIRP) and/or power spectral density (PSD) may be more limited than in licensed bands. For example, low-power indoor mode devices in 6 GHz bands may have maximum EIRPs of 30 dBm and 24 dBm for base stations (also referred to as “access points”) and UEs (also referred to as “clients” or “client devices”), respectively. Moreover, these low-power indoor mode devices in 6 GHz bands may have maximum PSDs of 5 dBm/MHz and −1 dBm/MHz for base stations and UEs, respectively. Accordingly, transmit power for these devices in unlicensed bands may be about 5-11 dBm smaller than in licensed bands (e.g., about 36 dBm and higher). Moreover, transmissions from UEs in unlicensed bands may be about 6 dBm smaller than transmissions from base stations in the same unlicensed bands. Smaller transmit power and transmit power mismatches between base stations and UEs, as described above, decrease communication reliability and/or quality.

Additionally, bandwidth for a component carrier in FR1 is typically capped at 100 MHz. In unlicensed bands, such as 5 GHz, 6 GHz, and/or the like, this cap is often smaller, such as 80 MHz. Accordingly, low-power indoor mode devices and other devices using unlicensed bands, such as 5 GHz, 6 GHz, and/or the like, cannot increase the bandwidth of component carriers sufficiently to increase transmit power to approach transmit power levels for licensed bands.

Techniques and apparatuses described herein allow UEs (e.g., UE 120) and base stations (e.g., base station 110) to aggregate component carriers within an unlicensed band and thereby increase transmit power. Techniques and apparatuses described herein allow for the base station 110 to transmit, and the UE 120 to receive, control resource sets in a wider bandwidth on account of the component carrier aggregation. By increasing transmit power for the control resource sets and/or other communications scheduled by those control resource sets, the base station 110 and the UE 120 may increase communication reliability and/or quality in the unlicensed band.

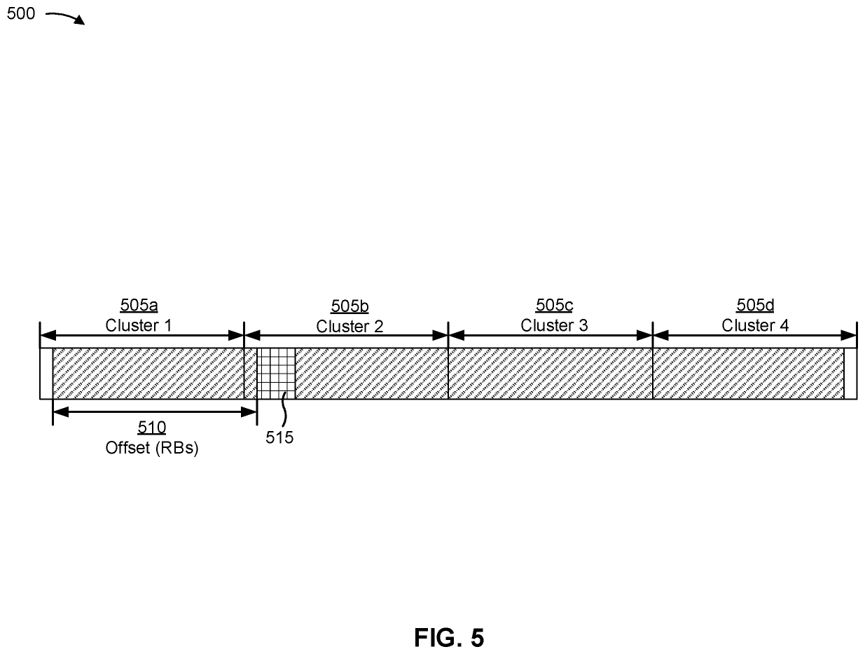

FIG. 5 is a diagram illustrating an example 500 of transmitting a control resource set in a wide bandwidth, in accordance with various aspects of the present disclosure. As shown in FIG. 5, example 500 includes a plurality of occasions for a control resource set transmitted by a base station (e.g., base station 110) and received by a UE (e.g., UE 120). The base station 110 and the UE 120 may be included in a wireless network, such as wireless network 100 illustrated and described above in connection with FIG. 1.

In some aspects, the base station 110 may transmit, and the UE 120 may receive, a broadcast message that indicates the plurality of occasions for the control resource set. For example, as shown in FIG. 5, the plurality of occasions may include four clusters (e.g., cluster 505a, cluster 505b, cluster 505c, and cluster 505d) of bandwidth for the control resource set. Although FIG. 5 and the description below will focus on four clusters, the description equally applies to any number of clusters, such as two, three, five, and/or the like. In some aspects, the broadcast message may include a master information block (MIB) message.

In some aspects, the control resource set shown in FIG. 5 may include a CORESET 0. Accordingly, the control resource set may schedule a remaining minimum system information (RMSI) PDCCH message, and the UE 120 may use the RMSI PDCCH to decode further broadcast messages from the base station 110.

In some aspects, the broadcast message may further indicate a number of symbols in the control resource set. In some aspects, the number of symbols may be no more than two. For example, the broadcast message may include or otherwise indicate a variable N_{symb}^{CORESET} that is set to either one or two such that the control resource set includes only one or two symbols.

Additionally, or alternatively, the broadcast message may further indicate an offset based at least in part on which occasion of the plurality of occasions includes a synchronization signal. For example, as shown in FIG. 5, offset 510 (expressed, for example, in resource blocks (RBs)) may be based at least in part on the location of synchronization signal 515 and a beginning of a first of the plurality of clusters (e.g., cluster 505a). In some aspects, the synchronization signal may include a synchronization signal block (SSB).

In some aspects, the plurality of occasions may be associated with a plurality of component carriers. In some aspects, the plurality of component carriers may be associated with an unlicensed band. For example, the unlicensed band may include at least one of a 5 GHz band, a 6 GHz band, or a combination thereof. Accordingly, the UE 120 may include a low-power indoor mode client, and/or the base station 110 may include a low-power indoor mode access point.

In some aspects, each occasion of the plurality of occasions may have a width of no more than 80 MHz. As shown in FIG. 5, the base station 110 may transmit, and the UE 120 may receive, the control resource set in a bandwidth that is larger than 80 MHz. In example 500, with four clusters, the base station 110 may transmit, and the UE 120 may receive, the control resource set across 320 MHz. In an alternative example, with two clusters, the base station 110 may transmit, and the UE 120 may receive, the control resource set across 160 MHz. As further shown in FIG. 5, the plurality of occasions may be contiguous along the unlicensed band.

In some aspects, the broadcast message may be based, at least in part, on a table of preconfigured values. For example, the table may be included in one or more technical specifications published by 3GPP and/or the like. Table 1 is an example of values used to determine the broadcast message for a CORESET 0 with subcarrier spacing (SCS) of 30 kHz for a synchronization signal (e.g., an SSB) and SCS of 30 kHz for a control message (e.g., a PDCCH message and/or the like).

TABLE 1

| | Multiplexing | Frequency pattern for | | |
|---|---|---|---|---|
| Index | pattern | CORESET 0 | N_{symb}^{CORESET} | Offset (RBs) |
| 0 | 1 | 48*4 | 1 | 0 |
| 1 | 1 | 48*4 | 2 | 0 |
| 2 | 1 | 48*4*2 | 1 | 0 |
| 3 | 1 | 48*4*2 | 2 | 0 |
| 4 | 1 | 48*4*2 | 1 | 192 |
| 5 | 1 | 48*4*2 | 2 | 192 |
| 6 | 1 | 48*4*3 | 1 | 0 |
| 7 | 1 | 48*4*3 | 2 | 0 |
| 8 | 1 | 48*4*3 | 1 | 192 |
| 9 | 1 | 48*4*3 | 2 | 192 |
| 10 | 1 | 48*4*3 | 1 | 384 |
| 11 | 1 | 48*4*3 | 2 | 384 |
| 12 | 1 | 48*4*4 | 1 | 0 |
| 13 | 1 | 48*4*4 | 1 | 192 |
| 14 | 1 | 48*4*4 | 1 | 384 |
| 15 | 1 | 48*4*4 | 1 | 576 |

Accordingly, in the example of Table 1, the broadcast message may include the index such that the UE 120 may determine the multiplexing pattern for the synchronization signal and the CORESET 0. The UE 120 may further use the index to determine a frequency pattern that defines a search space for further broadcast messages from the base station 110. For example, the broadcast message may include four bits (e.g., four most significant bits (MSBs) and/or four least significant bits (LSBs)) that define the plurality of occasions and the CORESET 0. The frequency pattern may define both a size of each occasion and a number of the plurality of occasions. For example, a frequency pattern of 48*4*2 indicates that each occasion is 48*4 RBs large and that the base station 110 is using two occasions. Similarly, a frequency pattern of 48*4*4 indicates that each occasion is 48*4 RBs large and that the base station 110 is using four occasions.

As further shown in Table 1, the offset may indicate which occasion of the plurality of occasions includes the cluster with a synchronization signal (such as an SSB and/or the like). The offset may be positive, as shown in example 500 of FIG. 5, when at least one cluster is earlier in time than the cluster with the synchronization signal.

Table 2 is another example of values that may be used to determine the broadcast message for a CORESET 0 with SCS of 15 kHz for a synchronization signal (e.g., an SSB and/or the like) and SCS of 15 kHz for a control message (e.g., a PDCCH message and/or the like).

TABLE 2

| | Multiplexing | Frequency pattern for | | |
|---|---|---|---|---|
| Index | pattern | CORESET 0 | N_{symb}^{CORESET} | Offset (RBs) |
| 0 | 1 | 96*4 | 1 | 0 |
| 1 | 1 | 96*4 | 2 | 0 |
| 2 | 1 | 96*4*2 | 1 | 0 |
| 3 | 1 | 96*4*2 | 2 | 0 |
| 4 | 1 | 96*4*2 | 1 | 384 |
| 5 | 1 | 96*4*2 | 2 | 384 |
| 6 | 1 | 96*4*3 | 1 | 0 |
| 7 | 1 | 96*4*3 | 2 | 0 |
| 8 | 1 | 96*4*3 | 1 | 384 |
| 9 | 1 | 96*4*3 | 2 | 384 |
| 10 | 1 | 96*4*3 | 1 | 768 |
| 11 | 1 | 96*4*3 | 2 | 768 |
| 12 | 1 | 96*4*4 | 1 | 0 |
| 13 | 1 | 96*4*4 | 1 | 384 |
| 14 | 1 | 96*4*4 | 1 | 768 |
| 15 | 1 | 96*4*4 | 1 | 1152 |

Accordingly, in the example of Table 2, the broadcast message may include the index such that the UE 120 may determine the multiplexing pattern for the synchronization signal and the CORESET 0. The UE 120 may further use the index to determine a frequency pattern that defines a search space for further broadcast messages from the base station 110. The frequency pattern may define both a size of each occasion and a number of the plurality of occasions. For example, a frequency pattern of 96*4*2 indicates that each occasion is 96*4 RBs large and that the base station 110 is using two occasions. Similarly, a frequency pattern of 96*4*4 indicates that each occasion is 96*4 RBs large and that the base station 110 is using four occasions.

As further shown in Table 2, the offset may indicate which occasion of the plurality of occasions includes the cluster with a synchronization signal (such as an SSB and/or the like). The offset may be positive, as shown in example 500 of FIG. 5, when at least one cluster is earlier in time than the cluster with the synchronization signal.

Accordingly, the UE 120 may monitor, based at least in part on the broadcast message, at least one occasion of the plurality of occasions. Similarly, the base station 110 may transmit, and the UE 120 may receive, the control resource set in at least one occasion of the plurality of occasions. For example, the base station 110 may transmit a CORESET 0 across a bandwidth wider than 80 MHz (e.g., 320 MHz as shown in FIG. 5, 160 MHz, and/or the like).

In some aspects, the UE 120 may receive, based at least in part on the monitoring, another broadcast message that schedules further transmissions from the base station. For example, the control resource set may schedule a PDCCH transmission from the base station 110 that the UE 120 may use to decode a system information block (SIB) message and/or other broadcast message from the base station 110.

By using the technique described in connection with FIG. 5, the base station 110 and the UE 120 may increase transmit power of the control resource set (e.g., CORESET 0) and subsequent communications. Accordingly, the base station 110 and the UE 120 may increase communication reliability and/or quality in the unlicensed band.

As indicated above, FIG. 5 is provided as an example. Other examples may differ from what is described with respect to FIG. 5.

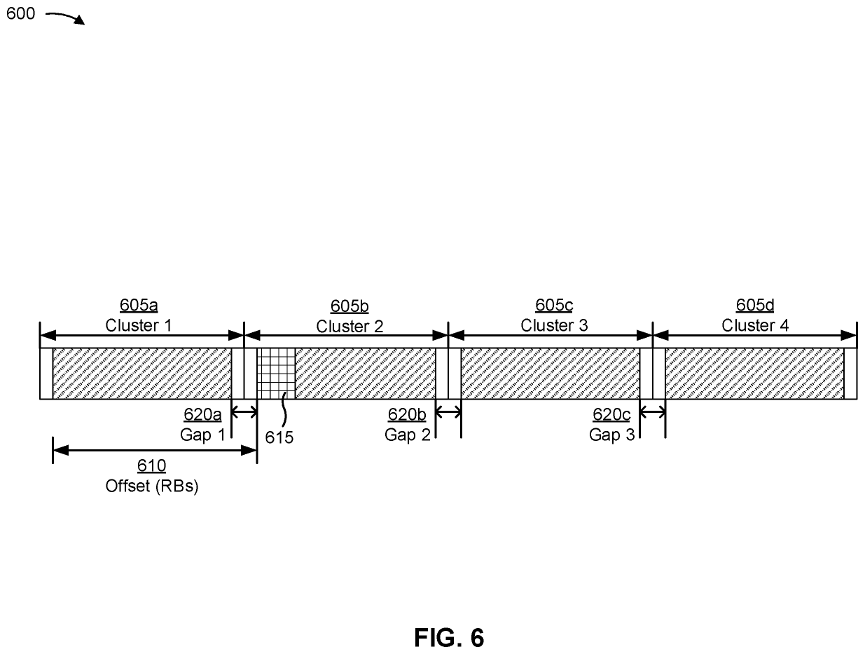

FIG. 6 is a diagram illustrating an example 600 of repeating a control resource set in a wide bandwidth, in accordance with various aspects of the present disclosure. As shown in FIG. 6, example 600 includes a plurality of occasions for a control resource set transmitted by a base station (e.g., base station 110) and received by a UE (e.g., UE 120). The base station 110 and the UE 120 may be included in a wireless network, such as wireless network 100 illustrated and described above in connection with FIG. 1.

In some aspects, the base station 110 may transmit, and the UE 120 may receive, a broadcast message that indicates the plurality of occasions for the control resource set. For example, as shown in FIG. 5, the plurality of occasions may include four clusters (e.g., cluster 605a, cluster 605b, cluster 605c, and cluster 605d) of bandwidth for the control resource set. Although FIG. 6 and the description below will focus on four clusters, the description equally applies to any number of clusters, such as two, three, five, and/or the like. In some aspects, the broadcast message may include an MIB message.

In some aspects, the control resource set shown in FIG. 6 may include a CORESET 0. Accordingly, the control resource set may schedule an RMSI PDCCH message, and the UE 120 may use the RMSI PDCCH to decode further broadcast messages from the base station 110.

In some aspects, the broadcast message may further indicate a number of symbols in the control resource set. In some aspects, the number of symbols may be no more than two. For example, the broadcast message may include or otherwise indicate a variable N_{symb}^{CORESET} that is set to either one or two such that the control resource set includes only one or two symbols.

Additionally, or alternatively, the broadcast message may further indicate an offset based at least in part on which occasion of the plurality of occasions includes a synchronization signal. For example, as shown in FIG. 6, offset 610 (expressed, for example, in RBs) may be based at least in part on the location of synchronization signal 615 and a beginning of a first of the plurality of clusters (e.g., cluster 605a). In some aspects, the synchronization signal may include an SSB.

In some aspects, the plurality of occasions may be associated with a plurality of component carriers. In some aspects, the plurality of component carriers may be associated with an unlicensed band. For example, the unlicensed band may include at least one of a 5 GHz band, a 6 GHz band, or a combination thereof. Accordingly, the UE 120 may include a low-power indoor mode client, and/or the base station 110 may include a low-power indoor mode access point.

In some aspects, each occasion of the plurality of occasions may have a width of no more than 80 MHz. As shown in FIG. 6, the plurality of occasions may be separated along the unlicensed band. For example, clusters 605a, 605b, 605c, and 605d may be separated by gaps 620a, 620b, and 620c. Although FIG. 6 depicts gaps 620a, 620b, and 620c as equal in size (e.g., equal in RBs), one or more of the gaps may be differently sized. In some aspects, the broadcast message may further indicate one or more gaps separating the plurality of occasions along the unlicensed band. Additionally, the control resource set may be repeated across the plurality of occasions. According, the base station 110 may transmit, and the UE 120 may receive, the control resource set across the plurality of occasions.

In some aspects, the broadcast message may be based, at least in part, on a table of preconfigured values. For example, the table may be included in one or more technical specifications published by 3GPP and/or the like. Table 3 is an example of values used to determine the broadcast message for a CORESET 0 with SCS of 30 kHz for a synchronization signal (e.g., an SSB and/or the like) and SCS of 30 kHz for a control message (e.g., a PDCCH message and/or the like).

TABLE 3

| | Multi- | | | |
|---|---|---|---|---|
| | plexing | Frequency pattern for | | Offset |
| Index | pattern | CORESET 0 | N_{symb}^{CORESET} | (RBs) |
| 0 | 1 | 48*4 | 1 | 0 |
| 1 | 1 | 48*4 | 2 | 0 |
| 2 | 1 | [48*4, 25, 48*4] | 1 | 0 |
| 3 | 1 | [48*4, 25, 48*4] | 2 | 0 |
| 4 | 1 | [48*4, 25, 48*4] | 1 | 217 |
| 5 | 1 | [48*4, 25, 48*4] | 2 | 217 |
| 6 | 1 | [48*4, 25, 48*4, 25, 48*4] | 1 | 0 |
| 7 | 1 | [48*4, 25, 48*4, 25, 48*4] | 2 | 0 |
| 8 | 1 | [48*4, 25, 48*4, 25, 48*4] | 1 | 217 |
| 9 | 1 | [48*4, 25, 48*4, 25, 48*4] | 2 | 217 |
| 10 | 1 | [48*4, 25, 48*4, 25, 48*4] | 1 | 434 |
| 11 | 1 | [48*4, 25, 48*4, 25, 48*4] | 2 | 434 |
| 12 | 1 | [48*4, 25, 48*4, 25, 48*4, 25, 48*4] | 1 | 0 |
| 13 | 1 | [48*4, 25, 48*4, 25, 48*4, 25, 48*4] | 2 | 217 |
| 14 | 1 | [48*4, 25, 48*4, 25, 48*4, 25, 48*4] | 1 | 434 |
| 15 | 1 | [48*4, 25, 48*4, 25, 48*4, 25, 48*4] | 2 | 651 |

Accordingly, in the example of Table 3, the broadcast message may include the index such that the UE 120 may determine the multiplexing pattern for the synchronization signal and the CORESET 0. The UE 120 may further use the index to determine a frequency pattern that defines a search space for further broadcast messages from the base station 110. For example, the broadcast message may include four bits (e.g., four MSBs and/or four LSBs) that define the plurality of occasions and the CORESET 0. The frequency pattern may define a size of each occasion, a number of the plurality of occasions, and a gap between each occasion. For example, a frequency pattern of [48*4, 25, 48*4] indicates that each occasion is 48*4 RBs large, that the base station 110 is using two occasions, and that a gap between the two occasions is 25 RBs. Similarly, a frequency pattern of [48*4, 25, 48*4, 25, 48*4, 25, 48*4] indicates that each occasion is 48*4 RBs large, that the base station 110 is using four occasions, and that each gap between occasions is 25 RBs.

As further shown in Table 3, the offset may indicate which occasion of the plurality of occasions includes the cluster with a synchronization signal (such as an SSB and/or the like). The offset may be positive, as shown in example 600 of FIG. 6, when at least one cluster is earlier in time than the cluster with the synchronization signal.

Table 4 is another example of values used to determine the broadcast message for a CORESET 0 with SCS of 15 kHz for a synchronization signal (e.g., an SSB and/or the like) and SCS of 15 kHz for a control message (e.g., a PDCCH message and/or the like).

TABLE 4

| | Multi- | | | |
|---|---|---|---|---|
| | plexing | Frequency pattern for | | Offset |
| Index | pattern | CORESET 0 | N_{symb}^{CORESET} | (RBs) |
| 0 | 1 | 96*4 | 1 | 0 |
| 1 | 1 | 96*4 | 2 | 0 |
| 2 | 1 | [96*4, 25, 96*4] | 1 | 0 |
| 3 | 1 | [96*4, 25, 96*4] | 2 | 0 |
| 4 | 1 | [96*4, 25, 96*4] | 1 | 434 |
| 5 | 1 | [96*4, 25, 96*4] | 2 | 434 |
| 6 | 1 | [96*4, 25, 96*4, 25, 96*4] | 1 | 0 |
| 7 | 1 | [96*4, 25, 96*4, 25, 96*4] | 2 | 0 |
| 8 | 1 | [96*4, 25, 96*4, 25, 96*4] | 1 | 434 |
| 9 | 1 | [96*4, 25, 96*4, 25, 96*4] | 2 | 434 |
| 10 | 1 | [96*4, 25, 96*4, 25, 96*4] | 1 | 868 |
| 11 | 1 | [96*4, 25, 96*4, 25, 96*4] | 2 | 868 |
| 12 | 1 | [96*4, 25, 96*4, 25, 96*4, 25, 96*4] | 1 | 0 |
| 13 | 1 | [96*4, 25, 96*4, 25, 96*4, 25, 96*4] | 2 | 434 |
| 14 | 1 | [96*4, 25, 96*4, 25, 96*4, 25, 96*4] | 1 | 868 |
| 15 | 1 | [96*4, 25, 96*4, 25, 96*4, 25, 96*4] | 2 | 1302 |

Accordingly, in the example of Table 4, the broadcast message may include the index such that the UE 120 may determine the multiplexing pattern for the synchronization signal and the CORESET 0. The UE 120 may further use the index to determine a frequency pattern that defines a search space for further broadcast messages from the base station 110. The frequency pattern may define both a size of each occasion and a number of the plurality of occasions. For example, a frequency pattern of [96*4, 25, 96*4] indicates that each occasion is 96*4 RBs large, that the base station 110 is using two occasions, and that a gap between the two occasions is 25 RBs. Similarly, a frequency pattern of [96*4, 25, 96*4, 25, 96*4, 25, 96*4] indicates that each occasion is 96*4 RBs large, that the base station 110 is using four occasions, and that each gap between occasions is 25 RBs.

As further shown in Table 4, the offset may indicate which occasion of the plurality of occasions includes the cluster with a synchronization signal (such as an SSB and/or the like). The offset may be positive, as shown in example 600 of FIG. 6, when at least one cluster is earlier in time than the cluster with the synchronization signal.

Accordingly, the UE 120 may monitor, based at least in part on the broadcast message, at least one occasion of the plurality of occasions. Similarly, the base station 110 may transmit, and the UE 120 may receive, the control resource set in at least one occasion of the plurality of occasions. For example, the base station 110 may repeat a CORESET 0 across a plurality of occasions, where each occasion has a bandwidth no more than 80 MHz.

In some aspects, the UE 120 may receive, based at least in part on the monitoring, another broadcast message that schedules further transmissions from the base station. For example, the control resource set may schedule a PDCCH transmission from the base station 110 that the UE 120 may use to decode a SIB message and/or other broadcast message from the base station 110.

By using the technique described in connection with FIG. 6, the base station 110 and the UE 120 may increase transmit power of the control resource set (e.g., CORESET 0) and subsequent communications. Accordingly, the base station 110 and the UE 120 may increase communication reliability and/or quality in the unlicensed band.

As indicated above, FIG. 6 is provided as an example. Other examples may differ from what is described with respect to FIG. 6.

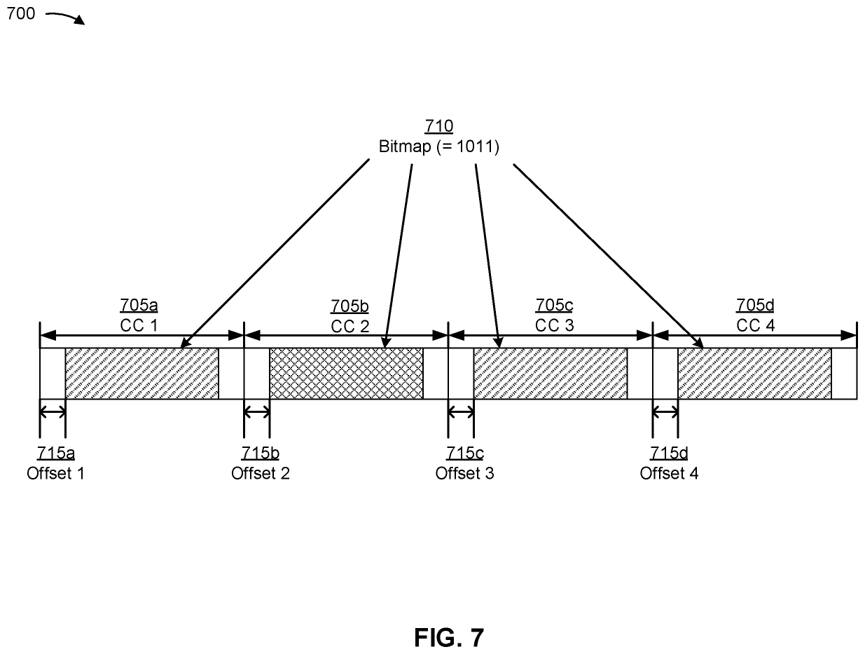

FIG. 7 is a diagram illustrating an example 700 of monitoring a wide bandwidth for a repeated control resource set, in accordance with various aspects of the present disclosure. As shown in FIG. 7, example 700 includes a plurality of occasions for at least one control resource set transmitted by a base station (e.g., base station 110) and received by a UE (e.g., UE 120). The base station 110 and the UE 120 may be included in a wireless network, such as wireless network 100 illustrated and described above in connection with FIG. 1.

In some aspects, the base station 110 may transmit, and the UE 120 may receive, a control message that indicates the plurality of occasions for the at least one control resource set. For example, as shown in FIG. 7, the plurality of occasions may include four component carriers (e.g., CC 705a, CC 705b, CC 705c, and CC 705d) for the control resource set. Although FIG. 7 and the description below will focus on four component carriers, the description equally applies to any number of component carriers, such as two, three, five, and/or the like.

In some aspects, the plurality of component carriers may be associated with an unlicensed band. For example, the unlicensed band may include at least one of a 5 GHz band, a 6 GHz band, or a combination thereof. Accordingly, the UE 120 may include a low-power indoor mode client, and/or the base station 110 may include a low-power indoor mode access point.

In some aspects, the control message may include an RRC message. For example, the control message may include a SIB message (e.g., with PDCCH-ConfigCommon) and/or a message specific to the UE 120.

In some aspects, the control resource set shown in FIG. 7 may include a CORESET for a search space other than Type0-PDCCH. Accordingly, the control resource set may schedule a PDCCH message, and the UE 120 may use the PDCCH to decode further messages (e.g., on a PDSCH and/or the like) from the base station 110.

In some aspects, the broadcast message may indicate a number of symbols in the control resource set. For example, the broadcast message may include or otherwise indicate a variable N_{symb}^{CORESET} that is set to either one, two, or three symbols.

Additionally, or alternatively, the control message may further indicate, for each occasion of the plurality of occasions, an offset based at least in part on a beginning of a search space within the occasion. For example, as shown in FIG. 7, offsets 715a, 715b, 715c, and 715d (expressed, for example, in RBs) may be based at least in part on a starting point for a control resource set and a bandwidth part edge, in each occasion of the plurality of component carriers.

In some aspects, each occasion of the plurality of occasions may have a width of no more than 80 MHz. According, in some aspects, the at least one control resource set may include a plurality of control resource sets, and each control resource set of the plurality of control resource sets may correspond to a respective occasion of the plurality of occasions. For example, the base station 110 may separately define a control resource set for each component carrier.

Additionally, or alternatively, and as shown in FIG. 7, the control message may further indicate a repetition pattern, within the plurality of occasions, for the at least one control resource set. For example, the base station 110 may define one control resource set and include a parameter (e.g., freqRepetitionLocation or other similar parameter), in the control message, that mirrors the control resource set across one or more of the component carriers.

In some aspects, as further shown in FIG. 7, the control message may include a bitmap 710 that indicates the repetition pattern. For example, bitmap 710 may be set to “1011” indicating that the base station 110 will transmit the control resource set in CC 705a, CC 705c, and CC 705d but not in CC 705b. Accordingly, the base station 110 may schedule additional messages (e.g., PDSCH messages) in CC 705b using cross-carrier scheduling (e.g., by transmitting PDCCH messages, to schedule the additional messages, in CC 705a, CC 705c, and/or CC 705d).

Accordingly, the UE 120 may monitor, based at least in part on the control message, at least one occasion of the plurality of occasions. Similarly, the base station 110 may transmit, and the UE 120 may receive, the control resource set in at least one occasion of the plurality of occasions. For example, the base station 110 may repeat a CORESET across occasions indicated by the control message, where each occasion has a bandwidth no more than 80 MHz.

In some aspects, the base station 110 may transmit, and the UE 120 may decode, scheduling information, where the scheduling information is repeated based at least in part on the repetition pattern, as described above. For example, the UE 120 may use soft-combination decoding based on the repetition across the search spaces (e.g., across CC 705a, CC 705c, and/or CC 705d).

In some aspects, the UE 120 may receive, based at least in part on the monitoring, another control message that schedules further transmissions from the base station. For example, the control resource set may schedule a PDCCH transmission from the base station 110, and the PDCCH transmission may schedule the further transmissions (e.g., PDSCH transmissions and/or the like), as described above.

By using the technique described in connection with FIG. 7, the base station 110 and the UE 120 may increase transmit power of the control resource set (e.g., CORESET) and subsequent communications. Accordingly, the base station 110 and the UE 120 may increase communication reliability and/or quality in the unlicensed band.

As indicated above, FIG. 7 is provided as an example. Other examples may differ from what is described with respect to FIG. 7.

FIG. 8 is a diagram illustrating an example process 800 performed, for example, by a UE, in accordance with various aspects of the present disclosure. Example process 800 is an example where the UE (e.g., UE 120 and/or the like) performs operations associated with scheduling cross-component carriers in unlicensed bands.

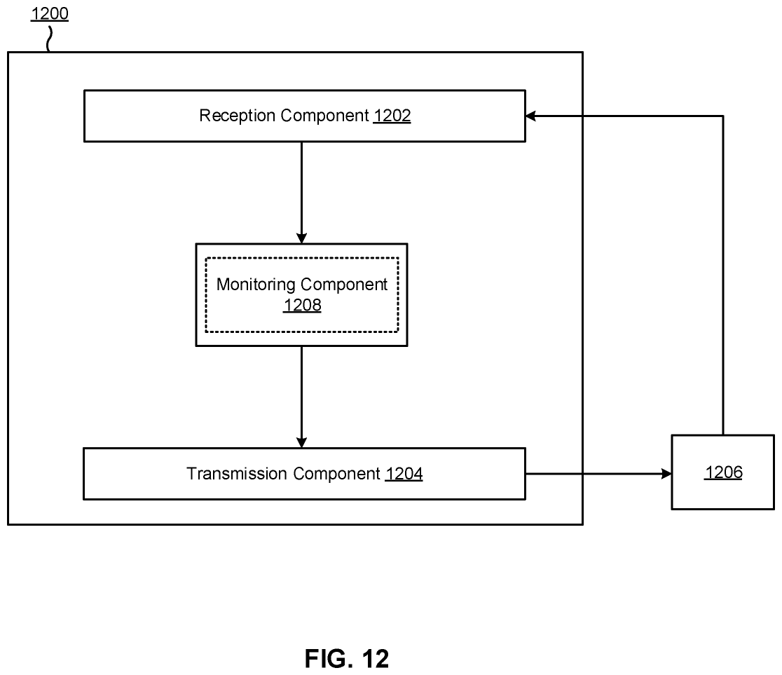

As shown in FIG. 8, in some aspects, process 800 may include receiving, from a base station (e.g., base station 110 and/or the like), a broadcast message that indicates a plurality of occasions for a control resource set (block 810). In some aspects, the operation shown by block 810 may be performed by reception component 1202 (see FIG. 12). For example, the UE (e.g., using receive processor 258, transmit processor 264, controller/processor 280, memory 282, and/or the like) may receive, from the base station, the broadcast message that indicates the plurality of occasions for the control resource set, as described above. In some aspects, the plurality of occasions are associated with a plurality of component carriers. In some aspects, the plurality of component carriers are associated with an unlicensed band.

As further shown in FIG. 8, in some aspects, process 800 may include monitoring, based at least in part on the broadcast message, at least one occasion of the plurality of occasions for the control resource set (block 820). In some aspects, the operation shown by block 820 may be performed by reception component 1202 and/or monitoring component 1208 (see FIG. 12). For example, the UE (e.g., using receive processor 258, transmit processor 264, controller/processor 280, memory 282, and/or the like) may monitor, based at least in part on the broadcast message, at least one occasion of the plurality of occasions for the control resource set, as described above.

Process 800 may include additional aspects, such as any single aspect or any combination of aspects described below and/or in connection with one or more other processes described elsewhere herein.

In a first aspect, process 800 further includes receiving, based at least in part on the monitoring, another broadcast message that schedules further transmissions from the base station.

In a second aspect, alone or in combination with the first aspect, the unlicensed band includes at least one of a 5 GHz band, a 6 GHz band, or a combination thereof.

In a third aspect, alone or in combination with one or more of the first and second aspects, each occasion of the plurality of occasions has a width of no more than 80 MHz.

In a fourth aspect, alone or in combination with one or more of the first through third aspects, the UE receives the control resource set in a bandwidth that is larger than 80 MHz.

In a fifth aspect, alone or in combination with one or more of the first through fourth aspects, the plurality of occasions are contiguous along the unlicensed band.

In a sixth aspect, alone or in combination with one or more of the first through fifth aspects, the plurality of occasions are separated along the unlicensed band, and the broadcast message further indicates one or more gaps separating the plurality of occasions along the unlicensed band.

In a seventh aspect, alone or in combination with one or more of the first through sixth aspects, the control resource set is repeated across the plurality of occasions, and the UE receives the control resource set across the plurality of occasions.

In an eighth aspect, alone or in combination with one or more of the first through seventh aspects, the broadcast message further indicates a number of symbols in the control resource set, and the number of symbols is no more than two.

In a ninth aspect, alone or in combination with one or more of the first through eighth aspects, the broadcast message further indicates an offset based at least in part on which occasion of the plurality of occasions includes a synchronization signal.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with various aspects of the present disclosure. Example process 900 is an example where the base station (e.g., base station 110 and/or the like) performs operations associated with scheduling cross-component carriers in unlicensed bands.

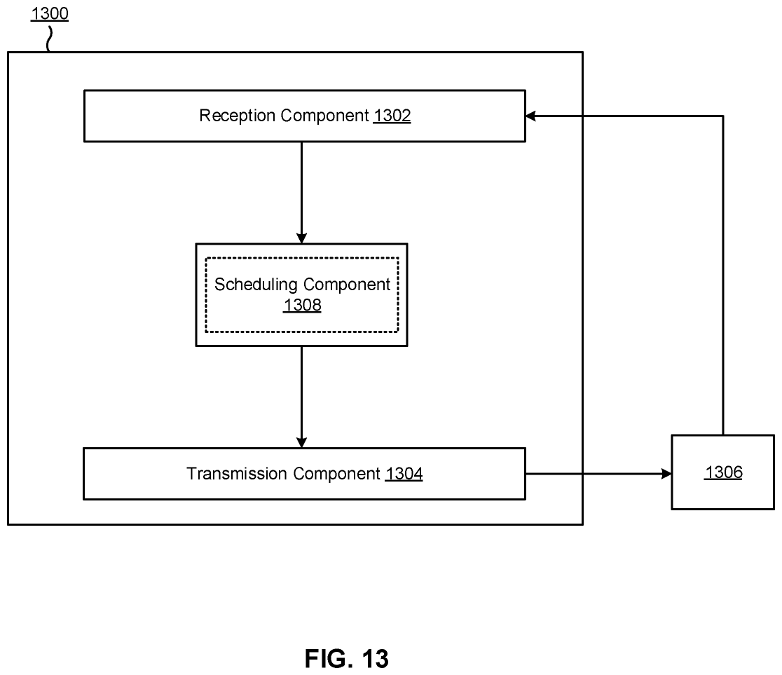

As shown in FIG. 9, in some aspects, process 900 may include transmitting, to a UE (e.g., UE 120 and/or the like), a broadcast message that indicates a plurality of occasions for a control resource set (block 910). In some aspects, the operation shown by block 910 may be performed by transmission component 1304 (see FIG. 13). For example, the base station (e.g., using transmit processor 220, receive processor 238, controller/processor 240, memory 242, and/or the like) may transmit, to the UE, the broadcast message that indicates the plurality of occasions for the control resource set, as described above. In some aspects, the plurality of occasions are associated with a plurality of component carriers. In some aspects, the plurality of component carriers are associated with an unlicensed band.

As further shown in FIG. 9, in some aspects, process 900 may include transmitting, to the UE and based at least in part on the transmission of the broadcast message, the control resource set in at least one occasion of the plurality of occasions (block 920). In some aspects, the operation shown by block 920 may be performed by transmission component 1304. For example, the base station (e.g., using transmit processor 220, receive processor 238, controller/processor 240, memory 242, and/or the like) may transmit, to the UE and based at least in part on the transmission of the broadcast message, the control resource set in at least one occasion of the plurality of occasions, as described above.

Process 900 may include additional aspects, such as any single aspect or any combination of aspects described below and/or in connection with one or more other processes described elsewhere herein.

In a first aspect, process 900 further includes transmitting, to the UE and based at least in part on the transmission of the control resource set, another broadcast message that schedules further transmissions from the base station.

In a second aspect, alone or in combination with the first aspect, the unlicensed band includes at least one of a 5 GHz band, a 6 GHz band, or a combination thereof.

In a third aspect, alone or in combination with one or more of the first and second aspects, each occasion of the plurality of occasions has a width of no more than 80 MHz.

In a fourth aspect, alone or in combination with one or more of the first through third aspects, the base station transmits the control resource set in a bandwidth that is larger than 80 MHz.

In a fifth aspect, alone or in combination with one or more of the first through fourth aspects, the plurality of occasions are contiguous along the unlicensed band.

In a sixth aspect, alone or in combination with one or more of the first through fifth aspects, the plurality of occasions are separated along the unlicensed band, and the broadcast message further indicates one or more gaps separating the plurality of occasions along the unlicensed band.

In a seventh aspect, alone or in combination with one or more of the first through sixth aspects, the control resource set is repeated across the plurality of occasions, and the base station transmits the control resource set across the plurality of occasions.

In an eighth aspect, alone or in combination with one or more of the first through seventh aspects, the broadcast message further indicates a number of symbols in the control resource set, and the number of symbols is no more than two.

In a ninth aspect, alone or in combination with one or more of the first through eighth aspects, the broadcast message further indicates an offset based at least in part on which occasion of the plurality of occasions includes a synchronization signal.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with various aspects of the present disclosure. Example process 1000 is an example where the UE (e.g., UE 120 and/or the like) performs operations associated with scheduling cross-component carriers in unlicensed bands.

As shown in FIG. 10, in some aspects, process 1000 may include receiving, from a base station (e.g., base station 110 and/or the like), a control message that indicates a plurality of occasions for at least one control resource set (block 1010). In some aspects, the operation shown by block 1010 may be performed by reception component 1202. For example, the UE (e.g., using receive processor 258, transmit processor 264, controller/processor 280, memory 282, and/or the like) may receive, from the base station, the control message that indicates the plurality of occasions for at least one control resource set, as described above. In some aspects, the plurality of occasions are associated with a plurality of component carriers. In some aspects, the plurality of component carriers are associated with an unlicensed band.

As further shown in FIG. 10, in some aspects, process 1000 may include monitoring, based at least in part on the control message, at least one occasion of the plurality of occasions for the at least one control resource set (block 1020). In some aspects, the operation shown by block 1020 may be performed by reception component 1202 and/or monitoring component 1208. For example, the UE (e.g., using receive processor 258, transmit processor 264, controller/processor 280, memory 282, and/or the like) may monitor, based at least in part on the control message, at least one occasion of the plurality of occasions for the at least one control resource set, as described above.

Process 1000 may include additional aspects, such as any single aspect or any combination of aspects described below and/or in connection with one or more other processes described elsewhere herein.

In a first aspect, process 1000 further includes receiving, based at least in part on the monitoring, another control message that schedules further transmissions from the base station.

In a second aspect, alone or in combination with the first aspect, the unlicensed band includes at least one of a 5 GHz band, a 6 GHz band, or a combination thereof.

In a third aspect, alone or in combination with one or more of the first and second aspects, each occasion of the plurality of occasions has a width of no more than 80 MHz.

In a fourth aspect, alone or in combination with one or more of the first through third aspects, the at least one control resource set includes a plurality of control resource sets, and each control resource set of the plurality of control resource sets corresponds to a respective occasion of the plurality of occasions.

In a fifth aspect, alone or in combination with one or more of the first through fourth aspects, the control message further indicates a repetition pattern, within the plurality of occasions, for the at least one control resource set.

In a sixth aspect, alone or in combination with one or more of the first through fifth aspects, the control message includes a bitmap that indicates the repetition pattern.

In a seventh aspect, alone or in combination with one or more of the first through sixth aspects, process 1000 further includes decoding scheduling information, received from the base station, based at least in part on the repetition pattern.

In an eighth aspect, alone or in combination with one or more of the first through seventh aspects, the control message further indicates, for each occasion of the plurality of occasions, an offset based at least in part on a beginning of a search space within the occasion.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with various aspects of the present disclosure. Example process 1100 is an example where the base station (e.g., base station 110 and/or the like) performs operations associated with scheduling cross-component carriers in unlicensed bands.

As shown in FIG. 11, in some aspects, process 1100 may include transmitting, to a UE (e.g., UE 120 and/or the like), a control message that indicates a plurality of occasions for at least one control resource set (block 1110). In some aspects, the operation shown by block 1110 may be performed by transmission component 1304. For example, the base station (e.g., using transmit processor 220, receive processor 238, controller/processor 240, memory 242, and/or the like) may transmit, to the UE, the control message that indicates the plurality of occasions for the at least one control resource set, as described above. In some aspects, the plurality of occasions are associated with a plurality of component carriers. In some aspects, the plurality of component carriers are associated with an unlicensed band.

As further shown in FIG. 11, in some aspects, process 1100 may include transmitting, to the UE and based at least in part on the transmission of the control message, the at least one control resource set in at least one occasion of the plurality of occasions (block 1120). In some aspects, the operation shown by block 1120 may be performed by transmission component 1304. For example, the base station (e.g., using transmit processor 220, receive processor 238, controller/processor 240, memory 242, and/or the like) may transmit, to the UE and based at least in part on the transmission of the control message, the at least one control resource set in at least one occasion of the plurality of occasions, as described above.

Process 1100 may include additional aspects, such as any single aspect or any combination of aspects described below and/or in connection with one or more other processes described elsewhere herein.

In a first aspect, process 1100 further includes transmitting, to the UE and based at least in part on the transmission of the at least one control resource set, another control message that schedules further transmissions from the base station.

In a second aspect, alone or in combination with the first aspect, the unlicensed band includes at least one of a 5 GHz band, a 6 GHz band, or a combination thereof.

In a third aspect, alone or in combination with one or more of the first and second aspects, each occasion of the plurality of occasions has a width of no more than 80 MHz.

In a fourth aspect, alone or in combination with one or more of the first through third aspects, the at least one control resource set includes a plurality of control resource sets, and each control resource set of the plurality of control resource sets corresponds to a respective occasion of the plurality of occasions.

In a fifth aspect, alone or in combination with one or more of the first through fourth aspects, the control message further indicates a repetition pattern, within the plurality of occasions, for the at least one control resource set.

In a sixth aspect, alone or in combination with one or more of the first through fifth aspects, the control message includes a bitmap that indicates the repetition pattern.

In a seventh aspect, alone or in combination with one or more of the first through sixth aspects, process 1100 further includes transmitting scheduling information, to the UE, wherein the scheduling information is repeated based at least in part on the repetition pattern.

In an eighth aspect, alone or in combination with one or more of the first through seventh aspects, the control message further indicates, for each occasion of the plurality of occasions, an offset based at least in part on a beginning of a search space within the occasion.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a monitoring component 1208, among other examples.

In some aspects, the apparatus 1200 may be configured to perform one or more operations described herein in connection with FIGS. 5-7. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the user equipment described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the user equipment described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the user equipment described above in connection with FIG. 2. In some aspects, the transmission component 1204 may be collocated with the reception component 1202 in a transceiver.

In some aspects, the reception component 1202 may receive, from the apparatus 1206 (e.g., a base station), a broadcast message that indicates a plurality of occasions for a control resource set. In some aspects, the plurality of occasions are associated with a plurality of component carriers, and the plurality of component carriers are associated with an unlicensed band. Moreover, the monitoring component 1208 may monitor, based at least in part on the broadcast message, at least one occasion of the plurality of occasions for the control resource set. In some aspects, the transmission component 1204 may confirm, to the apparatus 1206, when the reception component 1202 receives the broadcast message and/or the control resource set. For example, the transmission component 1204 may transmit, to the apparatus 1206, an acknowledgement signal and/or the like.

In some aspects, the reception component 1202 may receive, from the apparatus 1206 (e.g., a base station), a control message that indicates a plurality of occasions for at least one control resource set. In some aspects, the plurality of occasions are associated with a plurality of component carriers, and the plurality of component carriers are associated with an unlicensed band. Moreover, the monitoring component 1208 may monitor, based at least in part on the reception of the control message, at least one occasion of the plurality of occasions for the at least one control resource set. In some aspects, the transmission component 1204 may confirm, to the apparatus 1206, when the reception component 1202 receives the control message and/or the at least one control resource set. For example, the transmission component 1204 may transmit, to the apparatus 1206, an acknowledgement signal and/or the like.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a base station, or a base station may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a scheduling component 1308, among other examples.

In some aspects, the apparatus 1300 may be configured to perform one or more operations described herein in connection with FIGS. 5-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be collocated with the reception component 1302 in a transceiver.

In some aspects, the transmission component 1304 may transmit, to the apparatus 1306 (e.g., a UE), a broadcast message that indicates a plurality of occasions for a control resource set. In some aspects, the plurality of occasions are associated with a plurality of component carriers, and the plurality of component carriers are associated with an unlicensed band. Moreover, the transmission component 1304 may transmit, to the apparatus 1306 and based at least in part on the transmission of the broadcast message, the control resource set in at least one occasion of the plurality of occasions. For example, the transmission component 1304 may transmit the control resource set in accordance with a scheduling associated with further transmissions from the apparatus 1300 and determined at least in part by scheduling component 1308. In some aspects, the reception component 1302 may receive an acknowledgment signal or other confirmation, from the apparatus 1306, that the apparatus 1306 received the broadcast message and/or the control resource set.

In some aspects, the transmission component 1304 may transmit, to the apparatus 1306 (e.g., a UE), a control message that indicates a plurality of occasions for at least one control resource set. In some aspects, the plurality of occasions are associated with a plurality of component carriers, and the plurality of component carriers are associated with an unlicensed band. Moreover, the transmission component 1304 may transmit, to the apparatus 1306 and based at least in part on the transmission of the control message, the at least one control resource set in at least one occasion of the plurality of occasions. For example, the transmission component 1304 may transmit the at least one control resource set in accordance with a repetition pattern associated with further transmissions from the apparatus 1300 and determined at least in part by scheduling component 1308. In some aspects, the reception component 1302 may receive an acknowledgment signal or other confirmation, from the apparatus 1306, that the apparatus 1306 received the control message and/or the at least one control resource set.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors coupled to the memory, the one or more processors configured to:
receive, from a network, a broadcast message that indicates a plurality of occasions for a control resource set, wherein the plurality of occasions are associated with a plurality of component carriers, and wherein the plurality of component carriers are associated with an unlicensed band; and
monitor, based at least in part on the broadcast message, at least one occasion of the plurality of occasions for the control resource set.

2. The apparatus of claim 1, wherein the one or more processors are further configured to:
receive, based at least in part on the monitoring, another broadcast message that schedules further transmissions from the network.

3. The apparatus of claim 1, wherein the unlicensed band includes at least one of a 5 GHz band, a 6 GHz band, or a combination thereof.

4. The apparatus of claim 1, wherein each occasion of the plurality of occasions has a width of no more than 80 MHz.

5. The apparatus of claim 1, wherein the UE receives the control resource set in a bandwidth that is larger than 80 MHz.

6. The apparatus of claim 1, wherein the plurality of occasions are contiguous along the unlicensed band.

7. The apparatus of claim 1, wherein the plurality of occasions are separated along the unlicensed band, and wherein the broadcast message further indicates one or more gaps separating the plurality of occasions along the unlicensed band.

8. The apparatus of claim 7, wherein the control resource set is repeated across the plurality of occasions, and wherein the UE receives the control resource set across the plurality of occasions.

9. The apparatus of claim 1, wherein the broadcast message further indicates a number of symbols in the control resource set, and wherein the number of symbols is no more than two.

10. The apparatus of claim 1, wherein the broadcast message further indicates an offset based at least in part on which occasion of the plurality of occasions includes a synchronization signal.

11. An apparatus for wireless communication at a network node, comprising:
a memory; and
one or more processors coupled to the memory, the one or more processors configured to:
transmit a broadcast message that indicates a plurality of occasions for a control resource set, wherein the plurality of occasions are associated with a plurality of component carriers, and wherein the plurality of component carriers are associated with an unlicensed band; and
transmit, based at least in part on the transmission of the broadcast message, the control resource set in at least one occasion of the plurality of occasions.

12. The apparatus of claim 11, wherein the one or more processors are further configured to:
transmit, based at least in part on the transmission of the control resource set, another broadcast message that schedules further transmissions from the network node.

13. (canceled)

14. The apparatus of claim 11, wherein each occasion of the plurality of occasions has a width of no more than 80 MHz.

15. The apparatus of claim 11, wherein the network node transmits the control resource set in a bandwidth that is larger than 80 MHz.

16. The apparatus of claim 11, wherein the plurality of occasions are contiguous along the unlicensed band.

17. The apparatus of claim 11, wherein the plurality of occasions are separated along the unlicensed band, and wherein the broadcast message further indicates one or more gaps separating the plurality of occasions along the unlicensed band.

18. The apparatus of claim 17, wherein the control resource set is repeated across the plurality of occasions, and wherein the network node transmits the control resource set across the plurality of occasions.

19. The apparatus of claim 11, wherein the broadcast message further indicates a number of symbols in the control resource set, and wherein the number of symbols is no more than two.

20. The apparatus of claim 11, wherein the broadcast message further indicates an offset based at least in part on which occasion of the plurality of occasions includes a synchronization signal.

21. An apparatus for wireless communication at a user equipment (UE), comprising:
a memory; and
one or more processors coupled to the memory, the one or more processors configured to:
receive, from a network, a control message that indicates a plurality of occasions for at least one control resource set, wherein the plurality of occasions are associated with a plurality of component carriers, and wherein the plurality of component carriers are associated with an unlicensed band; and
monitor, based at least in part on the control message, at least one occasion of the plurality of occasions for the at least one control resource set.

22. The apparatus of claim 21, wherein the one or more processors are further configured to:
receive, based at least in part on the monitoring, another control message that schedules further transmissions from the network.

23. The apparatus of claim 21, wherein the unlicensed band includes at least one of a 5 GHz band, a 6 GHz band, or a combination thereof.

24. The apparatus of claim 21, wherein each occasion of the plurality of occasions has a width of no more than 80 MHz.

25. The apparatus of claim 21, wherein the at least one control resource set includes a plurality of control resource sets, and wherein each control resource set of the plurality of control resource sets corresponds to a respective occasion of the plurality of occasions.

26. The apparatus of claim 21, wherein the control message further indicates a repetition pattern, within the plurality of occasions, for the at least one control resource set.

27. The apparatus of claim 26, wherein the control message includes a bitmap that indicates the repetition pattern.

28. The apparatus of claim 26, wherein the one or more processors are further configured to:
decode scheduling information, received from the network, based at least in part on the repetition pattern.

29. The apparatus of claim 21, wherein the control message further indicates, for each occasion of the plurality of occasions, an offset based at least in part on a beginning of a search space within the occasion.

30. An apparatus for wireless communication at a network node, comprising:
a memory; and
one or more processors coupled to the memory, the one or more processors configured to:
transmit a control message that indicates a plurality of occasions for at least one control resource set, wherein the plurality of occasions are associated with a plurality of component carriers, and wherein the plurality of component carriers are associated with an unlicensed band; and
transmit, based at least in part on the transmission of the control message, the at least one control resource set in at least one occasion of the plurality of occasions.

31. The apparatus of claim 30, wherein the one or more processors are further configured to:
transmit, based at least in part on the transmission of the at least one control resource set, another control message that schedules further transmissions from the network node.

32. (canceled)

33. The apparatus of claim 30, wherein each occasion of the plurality of occasions has a width of no more than 80 MHz.

34. The apparatus of claim 30, wherein the at least one control resource set includes a plurality of control resource sets, and wherein each control resource set of the plurality of control resource sets corresponds to a respective occasion of the plurality of occasions.

35. The apparatus of claim 30, wherein the control message further indicates a repetition pattern, within the plurality of occasions, for the at least one control resource set.

36. (canceled)

37. The apparatus of claim 35, wherein the one or more processors are further configured to:
transmit scheduling information, wherein the scheduling information is repeated based at least in part on the repetition pattern.

38. The apparatus of claim 30, wherein the control message further indicates, for each occasion of the plurality of occasions, an offset based at least in part on a beginning of a search space within the occasion.

39-152. (canceled)
